(19) United States
(12) Patent Application Publication
(10) Pub. No.: US 2007/0217339 A1
(43) Pub. Date: Sep. 20, 2007

(54) Cross-layer QoS mechanism for video transmission over wireless LAN

(75) Inventor: Yun Zhao, San Mateo, CA (US)

Correspondence Address: THELEN REID BROWN RAYSMAN & STEINER LLP, 2225 EAST BAYSHORE ROAD, SUITE 210, PALO ALTO, CA, 94303, US

(73) Assignee: Hitachi, Ltd.

(21) Appl. No.: 11/378,789

(22) Filed: Mar. 16, 2006

(51) Int. Cl. H04J 1/16; H04J 3/16

(52) U.S. Cl. 370/252; 370/470; 370/469

(57) ABSTRACT

A cross-layer QoS management method comprises monitoring a sequence of video frames (e.g., I, P and B frames of an MPEG video sequence) in a layer above the MAC layer; determining video frame sizes and a pattern of video frames per unit time; predicting a future data rate for a future time based on the video frame sizes and the pattern of video frames per unit time; and adjusting parameters (e.g., AIFS, CW, CWmax, CWmin) in the MAC layer based on the predicted future data rate for the future time, the parameters being associated with a time value for allowing access to a wireless medium.

### TECHNICAL FIELD

This invention relates generally to wireless networks, and more particularly provides a cross-layer QoS mechanism for video transmission over a wireless LAN.

### BACKGROUND

As users experience the convenience of wireless connectivity, they are demanding increasing support. Typical applications include video streaming, video conferencing, distance learning, etc. Because wireless bandwidth availability is restricted, quality of service (QoS) management is increasingly important in 802.11 networks. IEEE 802.11e proposes to define QoS mechanisms for wireless gear that gives support to bandwidth-sensitive applications such as voice and video.

The original 802.11 media access control (MAC) protocol was designed with two modes of communication for wireless stations. The first mode, Distributed Coordination Function (DCF), is based on Carrier Sense Multiple Access with Collision Avoidance (CSMA/CA), sometimes referred to as “listen before talk.” A station waits for a quiet period on the network and then begins to transmit data and detect collisions. The second mode, Point Coordination Function (PCF), supports time-sensitive traffic flows. Wireless access points periodically send beacon frames to communicate network identification and management parameters specific to the wireless network. Between sending beacon frames, PCF splits the time into a contention-free period and a contention period. A station using PCF transmits data during contention-free periods.

Because DCF and PCF do not differentiate between traffic types or sources, IEEE proposed enhancements to both coordination modes to facilitate QoS. These changes are intended to fulfill critical service requirements while maintaining backward-compatibility with current 802.11 standards.

Enhanced Distribution Coordination Access (EDCA) introduces the concept of traffic categories. Using EDCA, stations try to send data after detecting that the medium is idle for a set time period defined by the corresponding traffic category. A higher-priority traffic category will have a shorter wait time than a lower-priority traffic category. While no guarantees of service are provided, EDCA establishes a probabilistic priority mechanism to allocate bandwidth based on traffic categories.

The IEEE 802.11e EDCA standard provides QoS differentiation by grouping traffic into four access classes (ACs), i.e. voice, video, best effort and background. The voice AC has the highest priority; the video AC has the second highest priority; the best effort AC has the third highest priority; and the background AC has the lowest priority. Each AC has its own transmission queue and its own set of medium access parameters. Traffic prioritization uses the medium access parameters—AIFS interval, contention window (CW), and transfer opportunity (TXOP)—defined on a per-class basis, to ensure that higher priority AC has relatively more medium access opportunity than a lower priority AC.

Generally, the Arbitration Interframe Space (AIFS) is the time interval that a station must sense the medium to be idle before invoking a backoff or transmission. A higher priority AC uses a smaller AIFS interval. The Contention Window (CW, CWmin and CWmax) indicates the number of backoff time slots until the station can access the medium. CW is randomly drawn from the range [1, CW-1] in a uniform manner. CW starts from CWmin and doubles every time a transmission fails until it reaches its maximum value CWmax. Then, CW holds its maximum value until the transmission exceeds its retry limit. A higher priority AC uses smaller CWmin and CWmax. The Transmission Opportunity (TXOP) indicates the maximum duration that an AC can be allowed to transmit frames after acquiring access to the medium.

With these parameters, EDCA works in the following manner: Before a station can initiate a transmission, it must sense the channel to be idle for at least an AIFS time interval. If the channel is still idle after the AIFS interval, the station invokes a backoff procedure using a backoff counter to count down a random number of backoff time slots. The station decrements the backoff counter by one as long as the channel is sensed to be idle. Once the backoff counter reaches zero, the station can initiate its transmission. If the station senses the channel to be busy during the backoff procedure, the station suspends its current backoff procedure and freezes its backoff counter until the channel is sensed to be idle for an AIFS interval again. Then, if the channel is still idle after the AIFS interval, the station will resume decrementing its remaining backoff counter. After each unsuccessful transmission, the contention window doubles until CWmax. Once the station acquires channel access, the station can initiate multiple frame transmissions without additional contention as long as the total transmission time does not exceed the TXOP duration. After a successful transmission, the contention window returns to CWmin. The level of QoS control for each AC is determined by the combination of the three medium access parameters and the number of competing stations in the network.

FIG. 1 is a timing diagram illustrating details of a prior art EDCA contention control protocol. As shown, as soon as the medium as noted as idle, information being transmitted for station 1 in access class 1 (“STA-A1”) is postponed for the AIFS interval for access class 1 (“AIFS[AC1]”). Similarly, information being transmitted for station k in access class 1 (“STA-Ak”) is postponed also for the AIFS interval for access class 1 (“AIFS[AC1]”). The information being sent by station 1 and the information being sent by station k are each additionally postponed a random number of backoff slots to reduce the likelihood of collision. Information being transmitted for station 1 in access class 2 (“STA-B I”) is postponed for the AIFS interval for access class 2 (“AIFS[AC2]”), which information is of lower priority than the information of access class 1 and which AIFS[AC2] is greater than AIFS[AC1]. As is well known, the AIFS values are greater than the DCF interframe space (“DIFS”), which is greater than the PCF interframe space (“PIFS”), which is greater than the short interframe space (“SIFS”).

Wireless local area networks (WLAN) have limitations for multimedia transmissions. For example, WLANs are designed for data transmission and are unsuited for delay-sensitive, bandwidth-intense multimedia applications (e.g., audio and video). The wireless medium has noisy channel propagation and narrow bandwidth. The QoS requirements (delay, jitter, bandwidth and bit error rate, etc.) are more stringent for robust video transmission. Also, the IEEE 802.11 retransmission mechanism has been designed to avoid excessive transport layer retransmissions due to noisy channels. While transport layer traffic has major benefits from MAC layer retransmission, interactive multimedia suffers from high jitter and delay and video streaming suffers from low throughput.

Accordingly, a system and method for increasing QoS in wireless LANs, especially for multimedia transmissions, are needed.

### SUMMARY

Current network layer strategy separates QoS support for each layer. That is, each layer of the OSI model (including the physical layer, MAC layer, network layer, transport layer and application layer) provides a separate solution to QoS concerns. This network layer strategy does not always result in optimal performance for multimedia transmission.

In one embodiment, a network traffic predictor predicts future network traffic patterns according to observed past traffic patterns. The predicted traffic information is passed to the MAC QoS enhancement protocol, 802.11e EDCA. The EDCA Traffic Categories parameters, CWₘᵢₙ, CWₘₐₓ, AIFS and retry limit may be determined and/or modified based upon the predicted traffic pattern, thereby allocating bandwidth for data transmission. Thus, bandwidth can be dynamically reallocated based on the predicted traffic patterns for a future time window. By reallocating bandwidth, QoS requirements (e.g., bandwidth, delay, jitter, bit error rate, etc.) may be satisfied.

In one embodiment, the present invention provides a cross-layer QoS mechanism with video prediction algorithms that provide higher throughput video transmission over wireless LAN and improve quality of service. Generally, video prediction algorithms in upper layers are used to forecast real-time video traffic, e.g., frame size, data rate, etc. Such embodiments may be used to provide reliable video transmission, including HDTV, video streaming, etc., over WLAN.

In one embodiment, the present invention provides a cross-layer QoS management method, comprising monitoring a sequence of video frames in a layer above the MAC layer; determining video frame sizes and a pattern of video frames per unit time; predicting a future data rate for a future time based on the video frame sizes and the pattern of video frames per unit time; and adjusting parameters in the MAC layer based on the predicted future data rate for the future time, the parameters associated with a time value for allowing access to a wireless medium.

The video frames may include MPEG video frames. The pattern of video frames may include a pattern of I, P and B frames. The step of determining the video frame sizes may include determining an average video frame size of the I, P and B frames. The step of predicting a future data rate may include applying a wavelet-domain prediction algorithm or a time-domain prediction algorithm. The parameters in the MAC layer may include at least one of AIFS, CW, CWmin and CWmax. The step of adjusting the parameters may occur only after determining a predicted future data rate change from the current data rate, wherein the change is greater than a threshold. The unit time may be based on the frame rate.

In another embodiment, the present invention provides a cross-layer QoS management system, comprising a video prediction module for monitoring a sequence of video frames in a layer above the MAC layer, determining video frame sizes and a pattern of video frames per unit time, and predicting a future data rate for a future time based on the video frame sizes and the pattern of video frames per unit time; and a parameter adjustment module in communication with the video prediction module for adjusting parameters in the MAC layer based on the predicted future data rate for the future time, the parameters associated with a time value for allowing access to a wireless medium.

The video frames may include MPEG video frames. The pattern of video frames may include a pattern of I, P and B frames. The video prediction module may determine the video frame sizes by determining an average video frame size of the I, P and B frames. The video prediction module may predicts a future data rate by applying a wavelet-domain prediction algorithm or a time-domain prediction algorithm. The parameters in the MAC layer may include at least one of AIFS, CW, CWmin and CWmax. The parameter adjustment module may adjust the parameters only after determining a predicted future data rate change from the current data rate, wherein the change is greater than a threshold. The unit time may be based on the frame rate.

In yet another embodiment, the present invention provides a cross-layer QoS management system, comprising means for monitoring a sequence of video frames in a layer above the MAC layer, for determining video frame sizes and a pattern of video frames per unit time, and for predicting a future data rate for a future time based on the video frame sizes and the pattern of video frames per unit time; and means for adjusting parameters in the MAC layer based on the predicted future data rate for the future time, the parameters associated with a time value for allowing access to a wireless medium.

### BRIEF DESCRIPTION OF THE DRAWINGS

FIG. 1 illustrates a prior art timing diagram of AIFS interval and the contention window.

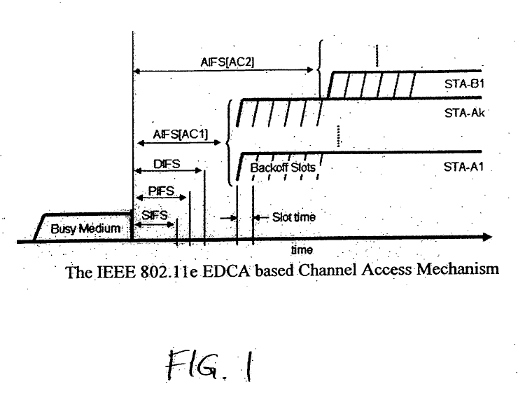

FIG. 2 is a block diagram illustrating an example station implementing a cross-layer video traffic pattern prediction mechanism, in accordance with an embodiment of the present invention.

FIG. 3 illustrates an example sequence of I, P and B frames.

FIG. 4 is a graph illustrating example frame sizes for the sequence of I, P and B frames of FIG. 3.

FIG. 5 illustrates an example architecture of the wavelet domain NLMS predictor, in accordance with an embodiment of the present invention.

FIG. 6 is a flowchart illustrating a cross-layer QoS managing method, in accordance with an embodiment of the present invention.

FIG. 7 is a block diagram of a computer system.

### DETAILED DESCRIPTION

The following description is provided to enable any person skilled in the art to make and use the invention, and is provided in the context of a particular application and its requirements. Various modifications to the embodiments are possible to those skilled in the art, and the generic principles defined herein may be applied to these and other embodiments and applications without departing from the spirit and scope of the invention. Thus, the present invention is not intended to be limited to the embodiments shown, but is to be accorded the widest scope consistent with the principles, features and teachings disclosed herein.

Current network layer strategy separates QoS support for each layer. That is, each layer of the OSI model (including the physical layer, MAC layer, network layer, transport layer and application layer) provides a separate solution to QoS concerns. This network layer strategy does not always result in optimal performance for certain, e.g., multimedia, transmission.

In one embodiment, a network traffic predictor predicts future network traffic patterns according to observed past traffic patterns. The predicted traffic information is passed to the MAC QoS enhancement protocol, 802.11e EDCA. The EDCA Traffic Categories parameters, CWₘᵢₙ, CWₘₐₓ, AIFS and retry limit may be determined and/or modified based upon the predicted traffic pattern, thereby allocating bandwidth for data transmission. Thus, bandwidth can be dynamically reallocated based on the predicted traffic patterns for a future time window. By reallocating bandwidth, QoS requirements (e.g., bandwidth, delay, jitter, bit error rate, etc.) may be satisfied.

In one embodiment, the present invention provides a cross-layer QoS mechanism with video prediction algorithms that provide higher throughput video transmission over wireless LAN and improve quality of service. Generally, video prediction algorithms in upper layers are used to forecast real-time video traffic, e.g., frame size, data rate, etc. Such embodiments may be used to provide reliable video transmission, including HDTV, video streaming, etc., over WLAN.

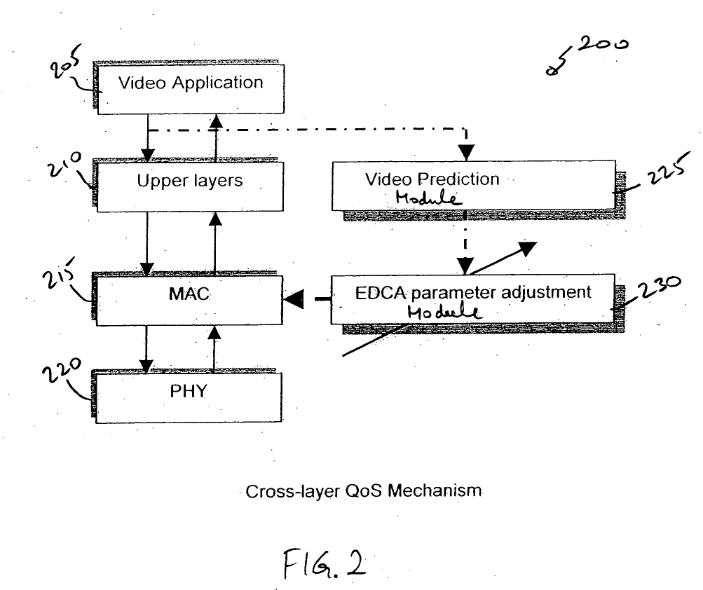

FIG. 2 illustrates a station 200 implementing a cross-layer video traffic pattern prediction mechanism, in accordance with an embodiment of the present invention. Station 200 includes a video application 205 in the application layer, upper layers 210 (which can include the application layer), a MAC layer 215, and a physical layer 220.

When acting as a source of video traffic, the video application 205 generates video data. The station 205 forwards the video data down though the upper layers 210 to the MAC layer 215, which performs EDCA-based procedures using AIFS, CW, CWmin, and CWmax. After an idle AIFS interval and backoff time period (using the general protocols described above), the station 200 transmits the video data to the wireless medium via the physical layer 220.

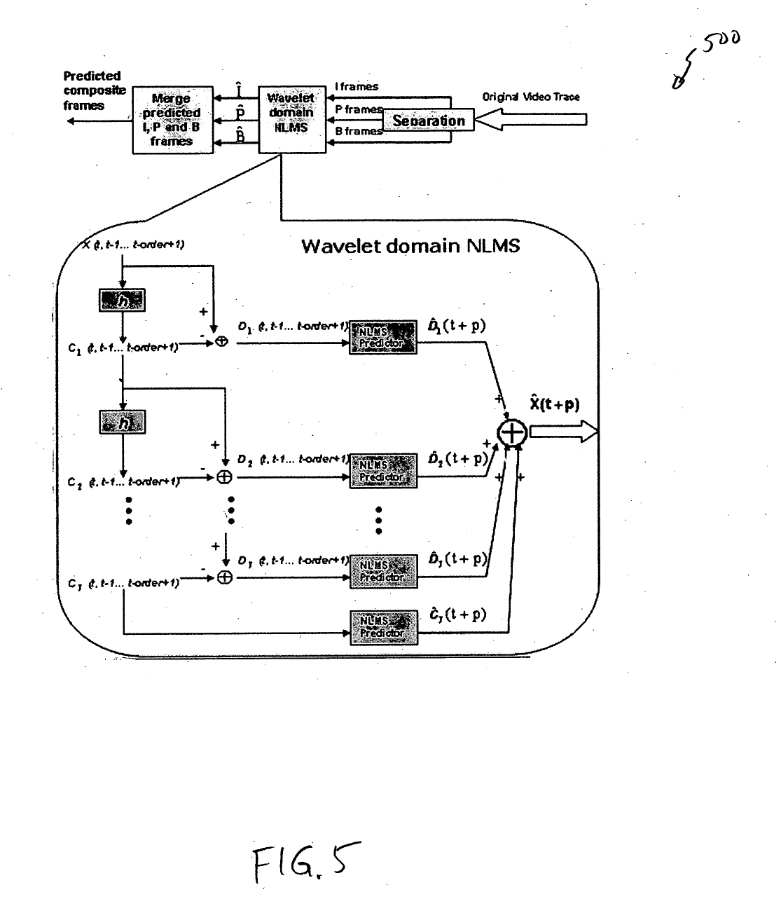

In this embodiment, the station 200 includes a video prediction module 225 that implements a video prediction algorithm for reviewing the video data, predicting the video traffic pattern, and based on the predicted pattern instructing an EDCA parameter adjustment module 230 at the MAC layer 215 to adjust EDCA parameters accordingly. The video prediction module 225 can be based on time-domain or wavelet-domain methodology. An example LMS prediction algorithm and an example wavelet domain prediction algorithm are described below and with reference to FIG. 5.

In one embodiment, the video prediction module 225 is configured to predict the pattern of an MPEG video stream, as MPEG is one of the most widely used video-encoding standards. An MPEG encoder that compresses a video signal at a constant picture (frame) rate produces a coded stream with variable bit rate. Three types of frames are generated during compression, namely, I-frame (Intra-frame), P-frame (Predictive-frame) and B-frame (Bidirectional-Predictive-frame), each with different encoding methods. I-frames have more bits than P-frames, which have more bits than B-frames.

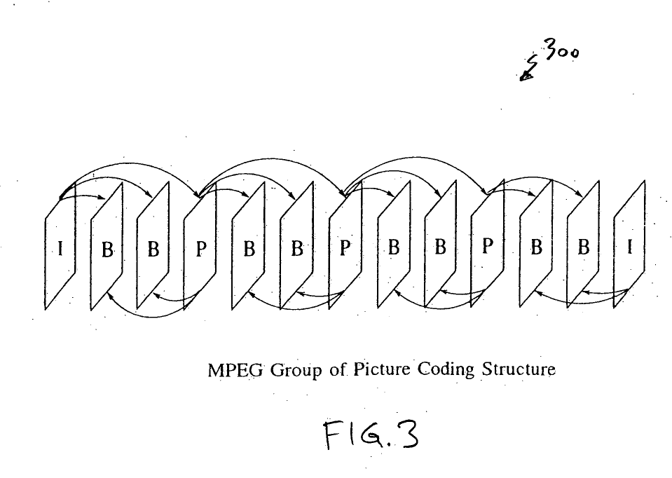

After encoding, the frames are arranged in a deterministic periodic sequence called a Group of Pictures (GOP), e.g. I B B P B B P B B P B B. FIG. 3 illustrates an example pattern 300 of a GOP with a length of 12 is I B B P B B P B B P B B I (the second I-frame being the start of the second GOP).

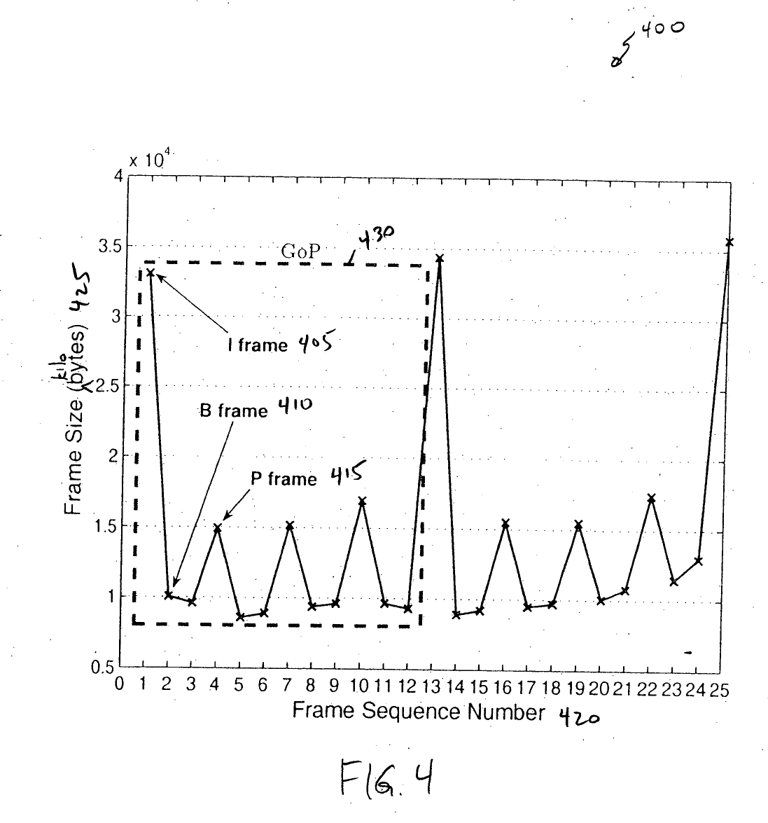

As a result of different compression rates of I, P and B frames, the MPEG video stream becomes a highly fluctuating time series. FIG. 4 is a graph 400 representing the frame size 425 for the example repeating sequence of frames illustrated in FIG. 3. In this example, I-frames 405 are shown to have a frame size of around 3.5 kilobytes. P-frames are shown to have a frame size of between 1.5 kilobytes. B-frames are shown to have a frame size of around 0.9 kilobytes. Frames 1-12 make up a first group of pictures (GOP) 430 before the frame pattern repeats.

By predicting the pattern of frames and the general frame size of the I, P and B frames and by synchronizing with the generally constant picture (frame) rate, the video prediction module 225 can predict the data rate necessary at any particular time. Then, by predicting the data rate necessary at a future time, the video prediction module 225 can instruct the EDCA parameter adjustment module 230 to modify the EDCA parameters in the MAC layer 215 to better approximate the variable data rate predicted.

At the beginning of transmission, default EDCA parameters may be implemented. After a period of time window T, if the change of predicted data rate is over a threshold, the EDCA parameters and protocol may be changed. For example, if the predicted data rate change is over a positive threshold (e.g., 30%) after the period of time window T, indicative of an increase in the traffic load, the EDCA parameters may be modified in the following way: the current AC category moves up to a higher priority (e.g., from AC1 to AC2). If the AC is at the highest priority, then the contention window backoff algorithm may be adjusted, e.g., set CWₘᵢₙ=CWₘᵢₙ/2; double the value of CW after every two retransmissions; set AIFS=DIFS, and/or the like. If the predicted data rate change is below a negative threshold (e.g., 30%) after the period of time window T, indicative of a decrease in the traffic load, the EDCA parameters may be modified in the following way: the current AC category moves down to a lower priority (e.g., from AC2 to AC1). If the AC is at the lowest priority, then the contention window backoff algorithm may be adjusted, e.g., set CWₘₐₓ=CWₘₐₓ×2 and/or double the value of CW after every retransmission.

In one embodiment, the video prediction algorithm separates I-frame, P-frame and B-frame prediction since the different types of frames have different statistical characteristics. To get better prediction results, differential prediction is utilized to compensate for variation noise.

As stated above, the video prediction module 225 can apply a Least Mean Square (LMS) prediction algorithm or a wavelet domain prediction algorithm.

Least Mean Square (LMS) Predictor: The k-step ahead LMS linear prediction algorithm involves the estimation of x(n+k) through a linear combination of the current and past values of x(n). A p^{th} order predicator can be expressed as

$$\hat{x} ( n + k ) = {\sum }_{l = 0}^{p - 1} {w}_{n} ( l ) x ( n - 1 ) = {w}_{n}^{T} X ( n ) , \qquad ( 1 )$$

where Wₙ is the prediction coefficient vector which is time varying and updated by minimizing the mean square error ξ, where
ε=E └e²(n)┘. (2)
X(n), Wₙ and e(n) are defined in (3) -(6), where μ is the step size
X⁽ⁿ⁾=[x(n),x(n−1), . . . ,x(n−p+1)]^{T} (3)
Wₙ=[wₙ(0),wₙ(1), . . . , wₙ(p−1)]^{T} (4)
Wₙ₋₁=Wₙ+μe(n)X(n) (5)
e(n)=x(n+k)−\hat{x}(n+k) (6)
The normalized LMS (NLMS) is a modification of LMS where Wₙ₊₁ is updated as

$${W}_{n + 1} = {W}_{n} + \frac{μ e ( n ) X ( n )}{‖ {X ( n )}^{2} ‖} \qquad ( 7 )$$

where ∥X(n)∥²=X(n)^{T}X(n). Since at time n, the value of x(n+k) is not available to compute e(n), e(n−k) is used instead of equation (7).

Wavelet Domain NLMS Predictor: A wavelet transform can be used for traffic analysis. A wavelet transform when combined with adaptive prediction shows advantages over its time-domain counterparts. Fundamentally, this may be due to the fact that the analyzing wavelet family itself possesses a scale invariant feature, a property not shared by other analysis methods.

An á trous wavelet transform may be used to decompose the video frames. The á trous Haar transform exploits redundant information by eliminating the down sampling effect to generate intact approximations and details. Using the á trous wavelet transform, the scaling coefficients at scale j can be obtained as

$$\begin{matrix}{C}_{0} ( t ) = x ( t ) , & ( 8 ) \\ {C}_{j} ( t ) = {\sum }_{l = - ∞}^{∞} h ( l ) {C}_{j - 1} ( t - {2}^{j - 1} l ) , & ( 9 )\end{matrix}$$

where 1≦j≦J and h is a low pass filter with compact support. The wavelet coefficients at scalej can be obtained by taking the difference of the successive smoothed version of the signal as
Dⱼ(t)=Cⱼ₋₁(t)−Cⱼ(t). (10)

The vector └D₁, D₂, . . . , Dⱼ, Cⱼ┘ represents the á trous wavelet transform of the signal up to resolution level J. The signal can be reconstructed as a linear combination of the wavelet and scaling coefficients

$$x ( t ) = {C}_{j} ( t ) + {\sum }_{j = 1}^{J} {D}_{j} ( t ) . \qquad ( 11 )$$

Many wavelet filters are available, such as Daubechies' family of wavelet filters, B3 spline filter, etc. Here we choose the Haar wavelet filter to implement the á trous wavelet transform. A major reason for choosing the Haar wavelet filter is that at any time instant t, the information after t never needs to be used to calculate the scaling and wavelet coefficients, which is a desirable feature in the time-series forecast. The Haar wavelet uses a simple filter h=(½; ½). The scaling coefficients at the higher scale can be easily obtained from the scaling coefficients at thelower scale.

In one embodiment, the wavelet-domain NLMS prediction scheme first separates the video frame into I, P and B subgroups and decomposes each subgroup into different scales using a trous Haar wavelet transform. Then, the wavelet coefficients and the scaling coefficients are predicted independently at each scale. Finally, the predicted values of the original frames can be construed as a sum of the predicted wavelet and scaling coefficients. The prediction of coefficients can be expressed as
Ĉⱼ(t+p)=NLMS(Cⱼ(t),Cⱼ(t−1), . . . Cⱼ(t−order+1)) (12)
\hat{D}ⱼ(t+p)=NLMS(Dⱼ(t),Dⱼ(t−1), . . . Dⱼ(t−order+1)) (13)
where NLMS represents the NLMS predictor and order is the length of the NLMS predictor. FIG. 5 shows an example architecture of wavelet decomposition and coefficients prediction mechanism 500 in accordance with an embodiment of the present invention.

One skilled in the art may find that using wavelet-domain NLMS prediction as compared to its time-domain counterpart has advantages. For example, NLMS prediction, when combined with a wavelet transform, allows the exploitation of the correlation structure at different time scales, which may not be easily examined in the time domain. Also, using a wavelet transform helps the NLMS to converge faster that its time domain counterpart. As a result, the wavelet-domain NLMS prediction algorithm may achieve better accuracy with a small computation complexity.

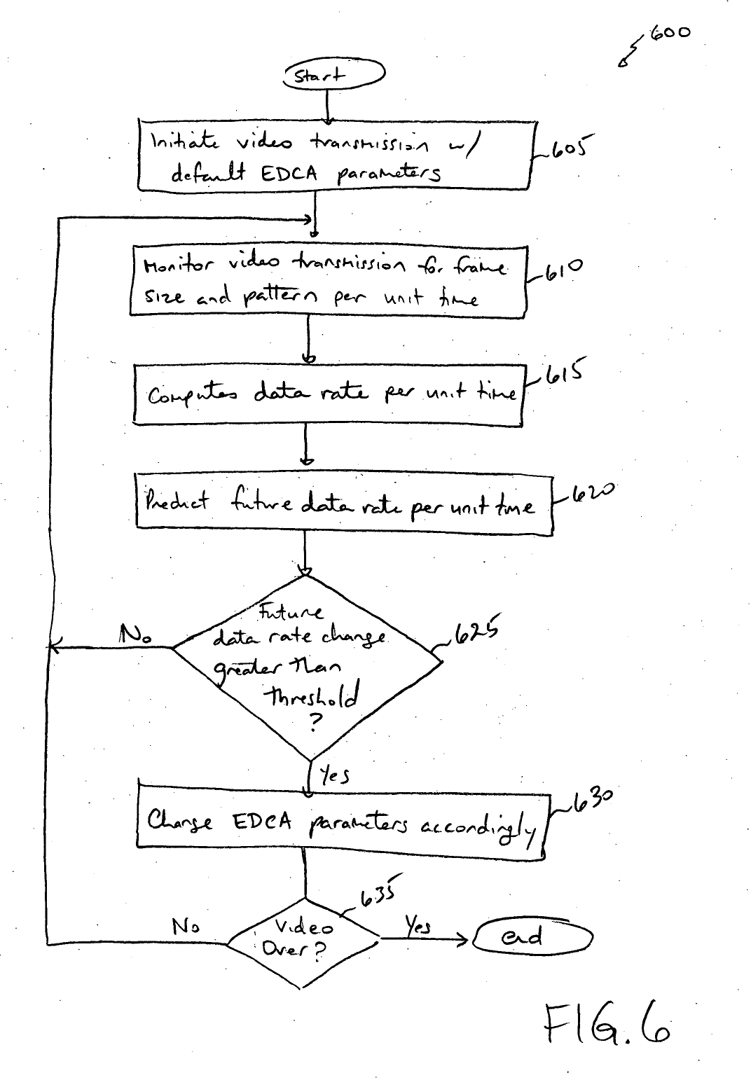

FIG. 6 is a flowchart illustrating a cross-layer QoS management method 600, in accordance with an embodiment of the present invention. Method 600 begins with the video application 205 in step 605 initiating a video transmission with default EDCA parameters in the MAC layer 215. The default EDCA parameters may be the EDCA parameters used in conventional EDCA systems. The video prediction module 225 in step 610 monitors the video transmission for frame size (e.g., frame size 425) and frame pattern (e.g., pattern 300) per unit time. Using the frame size and frame pattern per unit time, the video prediction module 225 in step 615 computes the data rate per unit time. Knowing the computed data rate per unit time, the video prediction module 225 in step 620 predicts the future data rate per unit time, and in step 625 determines whether the future data rate per unit time represents a data rate change (whether increase or decrease) from the current data rate by at least a predetermined threshold. If not, then method 600 returns to step 610. Otherwise, if so, the video prediction module 225 in step 630 instructs the EDCA parameter adjustment module 230 to change EDCA parameters accordingly. If in step 625 the video transmission is over, then the method 600 then ends. Otherwise, if the video transmission is not over, then method 600 returns to step 610 to continue monitoring. In cases where the frame pattern is absolutely fixed, then the method 600 can return to step 620 after steps 625 or step 635 since no additional monitoring may be needed (since the pattern and frame sizes per unit time have already been determined).

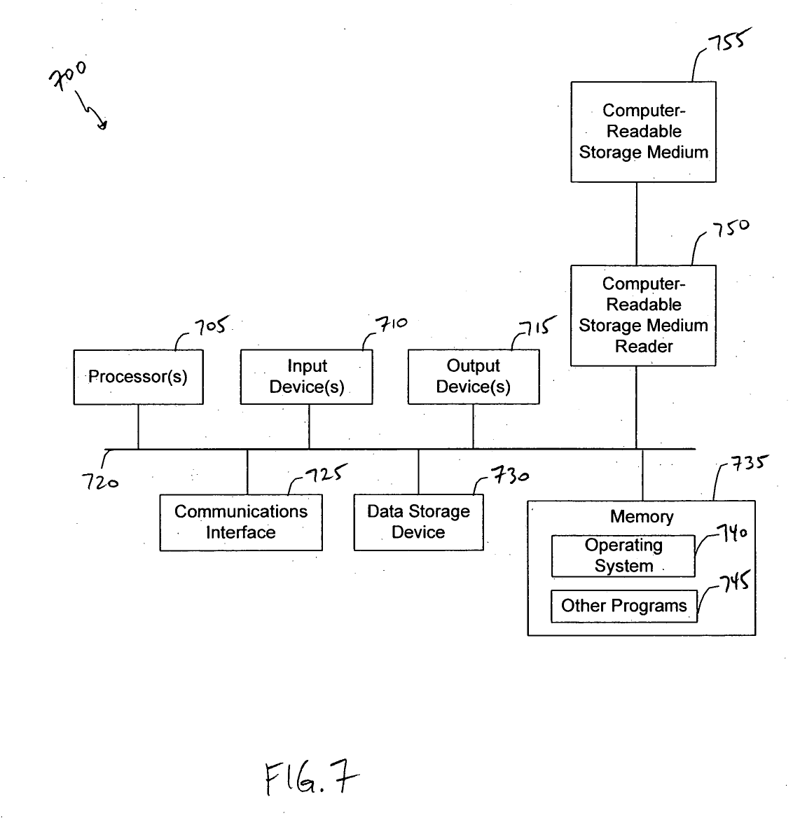

FIG. 7 is a block diagram illustrating details of an example computer system 700, of which each station 200 may be an instance. Computer system 700 includes a processor 705, such as an Intel Pentium® microprocessor or a Motorola Power PC® microprocessor, coupled to a communications channel 720. The computer system 700 further includes an input device 710 such as a keyboard or mouse, an output device 715 such as a cathode ray tube display, a communications device 725, a data storage device 730 such as a magnetic disk, and memory 735 such as Random-Access Memory (RAM), each coupled to the communications channel 720. The communications interface 725 may be coupled to a network such as the wide-area network commonly referred to as the Internet. One skilled in the art will recognize that, although the data storage device 730 and memory 735 are illustrated as different units, the data storage device 730 and memory 735 can be parts of the same unit, distributed units, virtual memory, etc.

The data storage device 730 and/or memory 735 may store an operating system 740 such as the Microsoft Windows NT or Windows/95 Operating System (OS), the IBM OS/2 operating system, the MAC OS, or UNIX operating system and/or other programs 745. It will be appreciated that a preferred embodiment may also be implemented on platforms and operating systems other than those mentioned. An embodiment may be written using JAVA, C, and/or C++ language, or other programming languages, possibly using object oriented programming methodology.

One skilled in the art will recognize that the computer system 700 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 750 such as a magnetic disk drive, hard disk drive, magneto-optical reader, CPU, etc. may be coupled to the communications bus 720 for reading a computer-readable storage medium (CRSM) 755 such as a magnetic disk, a hard disk, a magneto-optical disk, RAM, etc. Accordingly, the computer system 700 may receive programs and/or data via the CRSM reader 750. Further, it will be appreciated that the term “memory” herein is intended to cover all data storage media whether permanent or temporary.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A cross-layer QoS management method, comprising:
monitoring a sequence of video frames in a layer above the MAC layer;
determining video frame sizes and a pattern of video frames per unit time;
predicting a future data rate for a future time based on the video frame sizes and the pattern of video frames per unit time; and
adjusting parameters in the MAC layer based on the predicted future data rate for the future time, the parameters associated with a time value for allowing access to a wireless medium.

2. The method of claim 1, wherein the video frames are MPEG video frames.

3. The method of claim 1, wherein the pattern of video frames includes a pattern of I, P and B frames.

4. The method of claim 3, wherein the determining the video frame sizes includes determining an average video frame size of the I, P and B frames.

5. The method of claim 1, wherein the predicting a future data rate includes applying a wavelet-domain prediction algorithm.

6. The method of claim 1, wherein the predicting a future data rate includes applying a time-domain prediction algorithm.

7. The method of claim 1, wherein the parameters in the MAC layer include at least one of AIFS, CW, CWmin and CWmax.

8. The method of claim 1, wherein the adjusting the parameters occurs only after determining a predicted future data rate change from the current data rate, wherein the change is greater than a threshold.

9. The method of claim 1, wherein the unit time is based on the frame rate.

10. A cross-layer QoS management system, comprising:
a video prediction module for monitoring a sequence of video frames in a layer above the MAC layer, determining video frame sizes and a pattern of video frames per unit time, and predicting a future data rate for a future time based on the video frame sizes and the pattern of video frames per unit time; and
a parameter adjustment module in communication with the video prediction module for adjusting parameters in the MAC layer based on the predicted future data rate for the future time, the parameters associated with a time value for allowing access to a wireless medium.

11. The system of claim 10, wherein the video frames are MPEG video frames.

12. The system of claim 10, wherein the pattern of video frames includes a pattern of I, P and B frames.

13. The system of claim 12, wherein the video prediction module determines the video frame sizes by determining an average video frame size of the I, P and B frames.

14. The system of claim 10, wherein the video prediction module predicts a future data rate by applying a wavelet-domain prediction algorithm.

15. The system of claim 10, wherein the video prediction module predicts a future data rate by applying a time-domain prediction algorithm.

16. The system of claim 10, wherein the parameters in the MAC layer include at least one of AIFS, CW, CWmin and CWmax.

17. The system of claim 10, wherein the parameter adjustment module adjusts the parameters only after determining a predicted future data rate change from the current data rate, wherein the change is greater than a threshold.

18. The system of claim 10, wherein the unit time is based on the frame rate.

19. A cross-layer QoS management system, comprising:
means for monitoring a sequence of video frames in a layer above the MAC layer, for determining video frame sizes and a pattern of video frames per unit time, and for predicting a future data rate for a future time based on the video frame sizes and the pattern of video frames per unit time; and
means for adjusting parameters in the MAC layer based on the predicted future data rate for the future time, the parameters associated with a time value for allowing access to a wireless medium.
